(19) United States
(12) Patent Application Publication
(10) Pub. No.: US 2009/0241325 A1
(43) Pub. Date: Oct. 1, 2009

(54) HAND PRESS

(75) Inventor: Hideki MUKAI, Kahoku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/404,629

(22) Filed: Mar. 16, 2009

(30) Foreign Application Priority Data
Mar. 26, 2008 (JP) 2008-080901

(51) Int. Cl. B23P 19/02

(52) U.S. Cl. 29/739

(57) ABSTRACT

A hand press having an operation member provided at a main body with a pressure head section including a pressure head movable up and down relative to the main body and the pressure head section is configured to be pushed down by the operation member and to apply a pressing force, further, an elastic member is provided at the main body, and configured to apply an elastic force to the pressure head section such that a position of the pressure head located below a top dead center by a predetermined distance serves as an operation origin of the pressure head, and a switch is configured to turn ON when the pressure head section is located at a position above the operation origin.

### CROSS-REFERENCE TO RELATED APPLICATIONS

This application is based upon and claims the benefit of priority from the prior Japanese Patent Application No. 2008-80901, filed on Mar. 26, 2008, the entire contents of which are incorporated herein by reference.

### FIELD

An embodiment of the present invention relates to a hand press.

### BACKGROUND

To mount a connector on a circuit board, the connector to be connected to an electronic component has been soldered on the circuit board. Unfortunately, soldering results in poor manufacturing yield, and soldering on a thick board becomes difficult. Further, in view of environmental protection, use of a lead-free solder alloy has been promoted in recent years. However, soldering of a connector using the lead-free solder alloy is difficult depending on the material of the board.

Recently, a technique using a press-fit connector is becoming popular as a connection technique without using solder. FIG. 9 illustrates connection by pressing, in which a press-fit connector is mounted on a board. A through hole 98 is formed in a part of a terminal 92 of a connector 91. The diameter of the terminal 92 at the part in which the through hole 98 is formed is larger than the diameter of a through hole 99 formed in a board 93. In order to align the terminal 92 of the connector 91 with the through hole 99 of the board 93 for insertion of the connector 91, the board 93 is fixed on a receiving jig 95. A press head 96 applies a pressure to the connector 91 via a pressing jig 94 in a direction toward the board 93. Then, the terminal 92 is press-fitted into the through hole 99 of the board 93, the through hole 98 is caulked, and hence the terminal 92 is electrically and mechanically connected to the board 93.

Meanwhile, in such a hand press in which the press-fit connector is manually pressed and fitted into the board, the number of pressing works is counted for pressing-work number management. An example of counting the number of pressing works in the hand press may be a method in which the count of pressing works is incremented when the pressing pressure reaches a predetermined pressure, or a method in which the height of a movable portion of the press is detected and then the count of pressing works is incremented (see Patent Document 1).

However, various types of press-fit connectors are present, the number of terminals or pins provided at press-fit connectors varies, and various types of pressing jigs are necessary for the various types of press-fit connectors. The pressing pressure and the height of the top dead center depend on the type of press-fit connector. Thus, it is difficult to conduct the pressing-work number management by such a conventional method.

[Patent Document 1] Japanese Unexamined Patent Application Publication No. 2001-38495

### SUMMARY

An embodiment of the present invention provides a hand press capable of counting the number of pressing works for a variety of press subjects.

According to an embodiment of the invention, a hand press includes an operation member provided at a main body, a pressure head section including a pressure head movable up and down relative to the main body and the pressure head section configured to be pushed down by the operation member and to apply a pressing force, an elastic member provided at the main body, configured to apply an elastic force to the pressure head section such that a position of the pressure head located below a top dead center by a predetermined distance serves as an operation origin of the pressure head, and a switch configured to be turned ON when the pressure head section is located at a position above the operation origin.

### BRIEF DESCRIPTION OF THE DRAWINGS

FIG. 1 illustrates a hand press according to an embodiment of the present invention;

FIG. 2 illustrates the detail of a switch related structure of the hand press according to the embodiment;

FIG. 3 illustrates a specific example of the switch related structure of the hand press according to the embodiment;

FIGS. 4A and 4B illustrate operation of the hand press according to the embodiment;

FIG. 5 illustrates the flow of press fitting for a press-fit connector according to the embodiment;

FIG. 6 illustrates the flow of press fitting for the press-fit connector according to the embodiment;

FIG. 7 illustrates the flow of press fitting for the press-fit connector according to the embodiment;

FIG. 8 illustrates an example screen to instruct press fitting for the press-fit connector according to the embodiment; and

FIG. 9 illustrates conventional connection by pressing.

### DESCRIPTION OF EMBODIMENTS

An embodiment is described below with reference to the drawings.

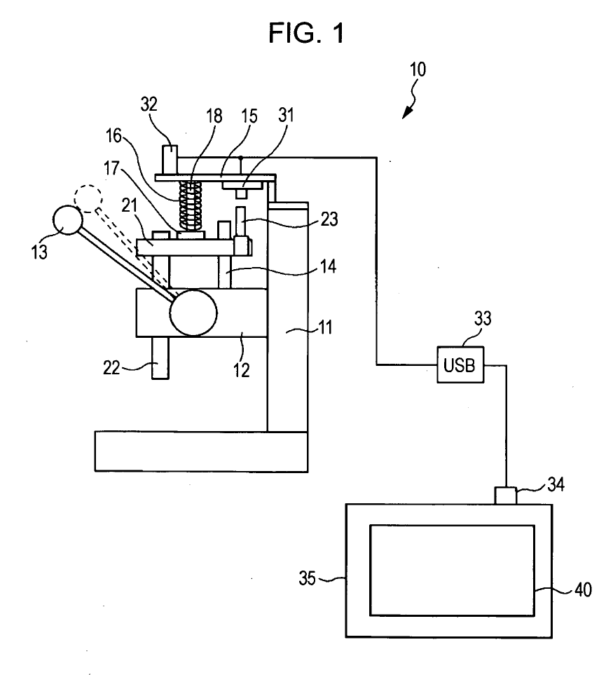

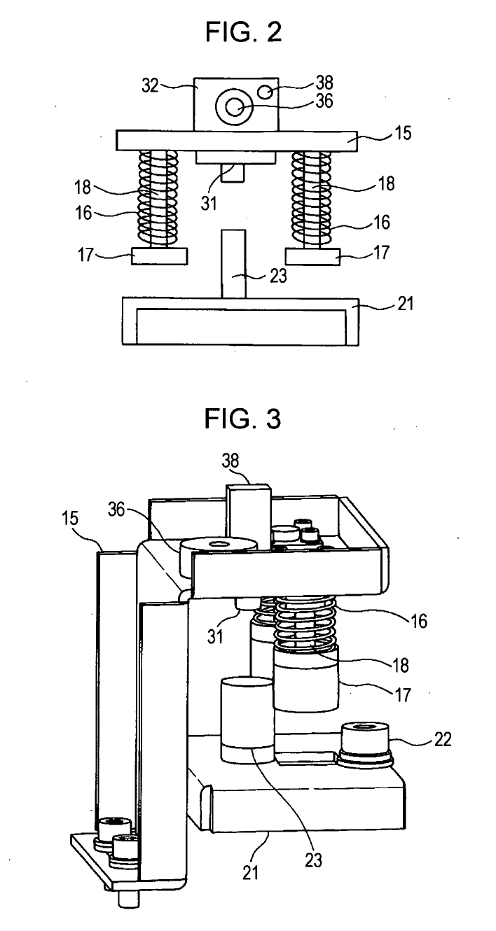

FIG. 1 is a side view illustrating a hand press of the embodiment. FIG. 2 is a front view illustrating the detail of a switch unit of the hand press shown in FIG. 1.

A hand press 10 includes a manual handle support member 12 horizontally extending from a hand press main body 11. A manual handle 13 is supported by the manual handle support member 12 and is rotatable in a vertical plane. The manual handle 13 is coupled to a pressure head 22 by, for example, a rack-and-pinion mechanism. The pressure head 22 moves while penetrating through the manual handle support member 12. The manual handle 13 is urged by, for example, a spring so as to be located at an upper position while the manual handle 13 is not pressed. The pressure head 22 is moved vertically down and presses a press-fit connector (not shown) arranged below the pressure head 22 when an operator pushes down on the manual handle 13.

An upper end portion of the pressure head 22 is fixed to a pressure head support plate 21. A columnar auxiliary shaft 14 is provided at the manual handle support member 12, the auxiliary shaft 14 penetrating through the pressure head support plate 21. The pressure head support plate 21 is guided by the auxiliary shaft 14, and is vertically moved up and down with the pressure head 22. In addition, a press rod 23 is attached to an upper surface of the pressure head support plate 21. The press rod 23 turns ON a switch, that is described later.

A switch support plate 15 is disposed in an upper portion of the hand press main body 11. The switch support plate 15 faces the pressure head support plate 21. A switch 31 is disposed on a lower surface of the switch support plate 15 such that the switch 31 faces the press rod 23. The switch 31 is turned ON when the press rod 23 presses the switch 31, and is turned OFF when the press rod 23 is released from the switch 31. The switch 31 does not have to be mechanically pressed by the press rod 23, and may be operated when the press rod 23 approaches to the switch 31.

Referring to FIG. 2, two coil springs 16 having rubber pieces 17 at tip ends of the coil springs 16 are disposed on the lower surface of the switch support plate 15. Also, shock absorbers 18 are arranged in the hand press 10 respectively at positions surrounded by the coil springs 16. The shock absorbers 18 are respectively coupled to the rubber pieces 17.

In a condition illustrated in FIG. 1, the coil springs 16 are in contact with the pressure head support plate 21, and slightly vertically push down the pressure head support plate 21. If the pressure head support plate 21 is not pushed down by the coil spring 16, the manual handle 13 is located at a position indicated by a broken line illustrated in FIG. 1, that is, at a top dead center. The position of the manual handle 13 which has been slightly moved down is a reference position of operation in this embodiment, that is, an operation origin. In the hand press 10 in this embodiment, since the pressure head support plate 21 is pushed down by the coil springs 16, the press rod 23 is separated from the switch 31 while the manual handle 13 is located at the operation origin, and hence, the switch 31 is OFF.

Though described later in detail, when the pressure head 22 is recovered after pressing, the switch 31 is pressed by the press rod 23, thereby being turned ON. Since the hand press 10 has the shock absorbers 18, a shock applied by the press rod 23 to the switch 31 can be reduced. Further, by changing the damping factor of the shock absorbers 18, a variety of hand presses may be used.

The switch 31 is connected to a notifying unit 32 including a buzzer and/or a light emitting diode (LED). Also, the switch 31 is connected to a terminal, such as a USB terminal 34 via a USB circuit 33. The USB terminal 34 is connected to an information processor such as a personal computer (PC) 35. The PC 35 has a display unit 40. The display unit 40 can display a connector, a press-fitting jig, etc., which are necessary for pressing. The screen displayed on the display unit 40 can be changed to a screen that instructs next work in accordance with the count result of the number of pressing works.

FIG. 2 is a front view illustrating a switch related structure of the hand press in the middle of the manual handle 13 being pushed down. In the state in FIG. 2, the manual handle 13 is pushed down with respect to the operation origin, and hence the pressure head support plate 21 is moved down as compared with the state in FIG. 1. When the manual handle 13 is located at the operation origin, the rubber pieces 17, which are in contact with the pressure head support plate 21, are separated from the pressure head support plate 21. Thus, the press rod 23 is separated from the switch 31 as compared with the state in which the manual handle 13 is located at the operation origin. The notifying unit 32 includes a buzzer 36 and an LED 38. The number of members each including the coil spring 16, the shock absorber 18, and the rubber piece 17 is not limited to two. A single member or more than two members may be provided.

FIG. 3 illustrates a specific example of the switch related structure of the hand press according to this embodiment.

The switch support plate 15 is mounted in the upper portion of the hand press such that the switch support plate 15 faces the upper surface of the pressure head support plate 21.

The pressure head support plate 21 supports the pressure head 22 and is vertically moved up and down with the pressure head 22. FIG. 3 only shows the upper end portion of the pressure head 22. The press rod 23 is disposed on the upper surface of the pressure head support plate 21. The press rod 23 faces the switch 31.

The switch 31 is disposed on the lower surface of the switch support plate 15. The switch 31 maybe a push-button switch which is turned ON when the press rod 23 presses the switch 31, and is turned OFF when the press rod 23 is separated from the switch 31. In addition, the coil springs 16 having the rubber pieces 17 at lower ends of the coil springs 16, and the shock absorbers 18 are disposed on the lower surface of the switch support plate 15. The buzzer 36 and the LED 38 are arranged on the upper surface of the switch support plate 15. When the switch 31 is turned ON, the buzzer 36 generates sound and the LED 38 emits light.

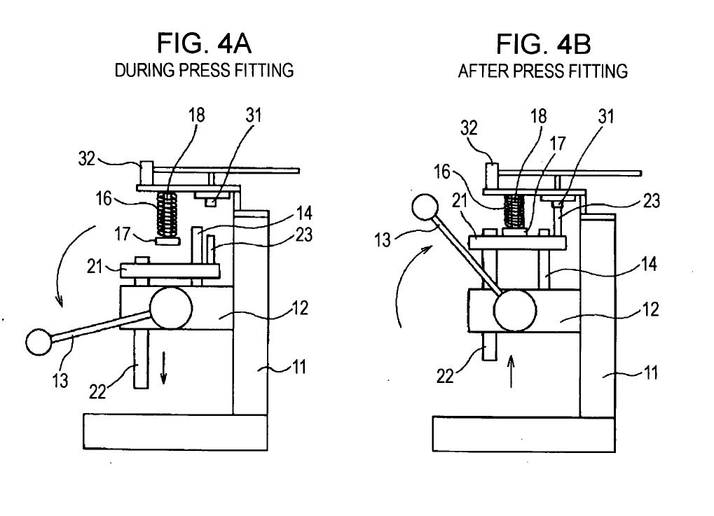

FIGS. 4A and 4B illustrate operation of the hand press. FIG. 4A illustrates a state during press fitting, in particular, a state in which the press-fit connector is press-fitted into the board when the manual handle 13 is pushed down and the pressure head 22 is moved down. Like FIG. 2, when the manual handle 13 is located at the operation origin, the rubber pieces 17, which are in contact with the pressure head support plate 21, are separated or released from the pressure head support plate 21. The press rod 23 is separated from the switch 31 similarly.

FIG. 4B illustrates a state after completion of press fitting, in particular, a state in which press fitting of the press-fit connector is completed when the operator releases the manual handle 13 or when the operator holds the manual handle and moves up the manual handle with respect to the operation origin.

The hand press has a spring (not shown) that urges the manual handle 13 and the pressure head 22 upward. Hence, when the operator releases the manual handle 13, the manual handle 13 and the pressure head support plate 21 are moved up beyond the operation origin by the spring force. The pressure head support plate 21 exceeding the operation origin is moved up against the elastic force of the coil springs 16. Since the pressure head support plate 21 is moved up beyond the operation origin, the press rod 23 provided at the pressure head support plate 21 turns ON the switch 31.

Even when the operator holds the manual handle and moves up the manual handle beyond the operation origin, the switch 31 is turned ON similarly.

When the switch 31 is turned ON, the buzzer of the notifying unit 32 generates sound and the LED of the notifying unit 32 emits light to notify the operator that a single cycle of pressing work is completed. Simultaneously, an ON signal of the switch 31 is input to the PC via the USB terminal, and is used as control information of the hand press.

The coil springs 16 are adjusted so as to turn ON the switch 31 even when the operator releases the manual handle 13 at a position near the operation origin. The shock absorbers 18 are adjusted so as to reduce the shock applied to the switch 31 when the operator releases the manual handle 13 at a lower position.

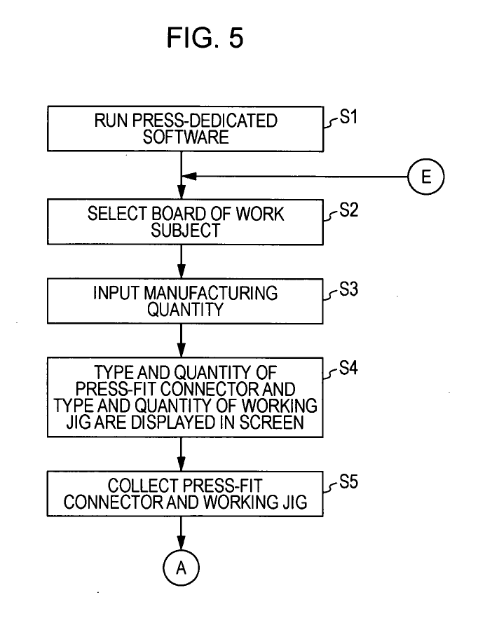

FIGS. 5 to 7 illustrate the flow of press-fitting for the press-fit connector.

Referring to FIG. 5, the operator starts a press-dedicated software operable with the PC 35 (S1). When the press-dedicated software runs, the display unit 40 displays a list of various boards. The operator selects a board as a work subject (S2). The board as the work subject can be selected from a pull-down menu in a box 42 that is displayed on the screen of the display unit 40. Then, the operator inputs a manufacturing quantity of the selected board (S3). When inputting of the manufacturing quantity is completed, the type and quantity of press-fit connectors and the type and quantity of working jigs are displayed in the screen (S4). The operator prepares the press-fit connectors as press subjects and the working jigs, the type of working jigs corresponding to the type of press-fit connectors (S5).

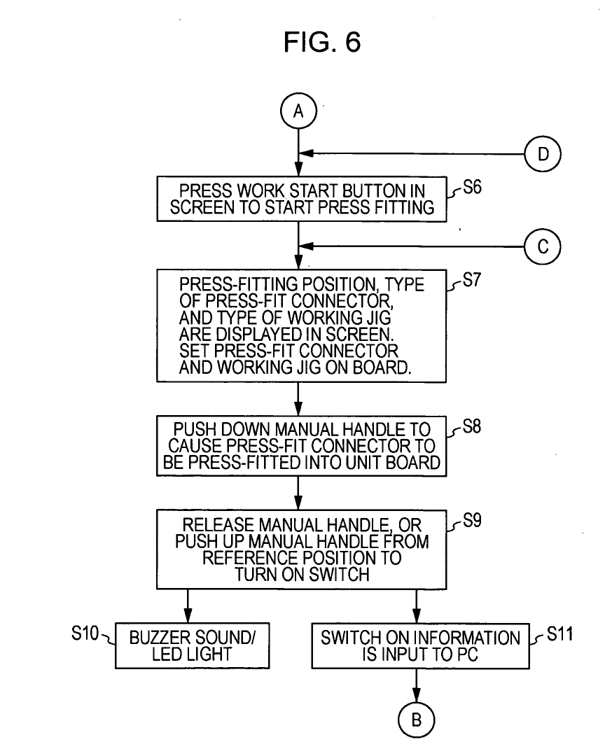

Referring to FIG. 6, after the press-fit connectors and the working jigs necessary for press fitting are collected, the operator presses a work start button displayed in the screen of the PC 35, and starts press fitting (S6). When the work start button in the screen is pressed, a press-fitting position, the type of press-fit connector, the type of working jig, etc., are displayed in the screen (S7).

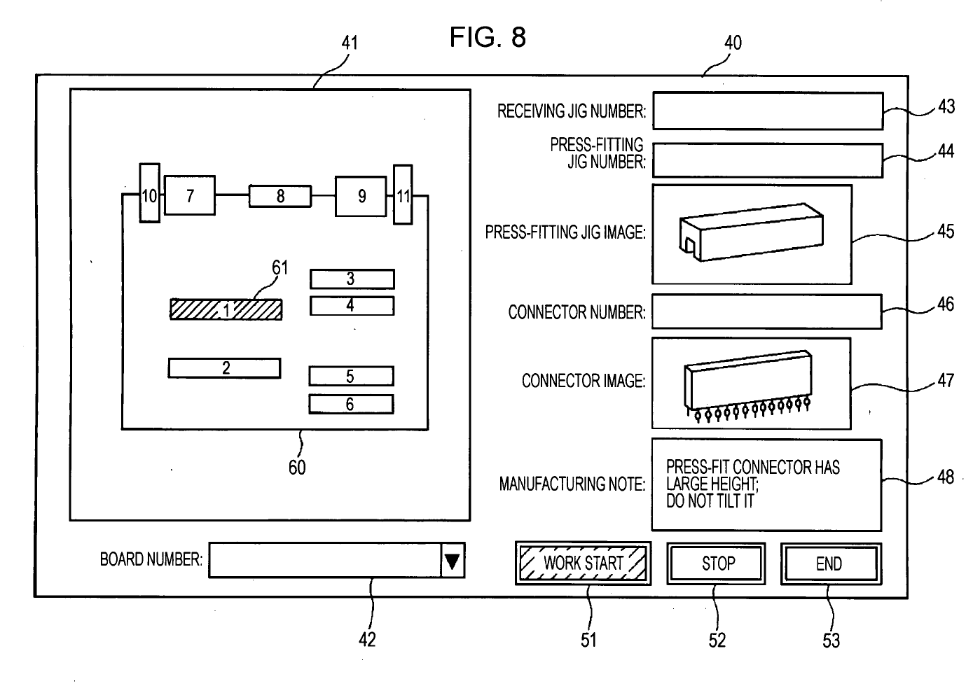

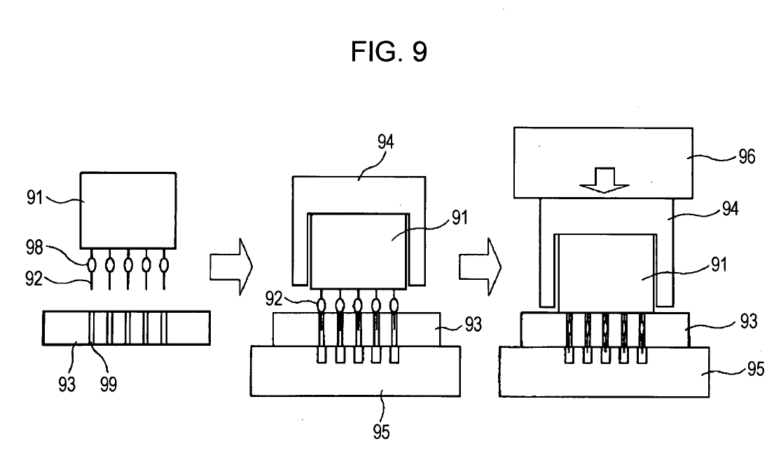

FIG. 8 illustrates an example of a screen to instruct press fitting for the press-fit connector. FIG. 8 illustrates the screen displayed on the display unit 40 when the operator presses a work start button 51 in the screen.

A window 41 in the screen on the display unit 40 displays a board 60 to show the positions of connectors to be mounted on the board 60. Further, the order of pressing works is indicated at the positions of the connectors. When the work start button 51 is pressed, the screen displays that a press-fit connector 61 on the board 60 is selected. The box 42 indicates a number representing the type of board 60.

A box 43 indicates a receiving jig number representing the type of receiving jig. A box 44 indicates a press-fitting jig number representing the type of press-fitting jig. A box 45 indicates an image of the press-fitting jig corresponding to the press-fitting jig number. A box 46 indicates a connector number representing the type of connector to be press-fitted. A box 47 indicates an image of the connector corresponding to the connector number. A box 48 indicates notes and tips for the work.

The operator places a board at a certain position of the hand press on the basis of the content in the screen. The operator also sets the press-fit connector, the receiving jig, and the press-fitting jig at instructed positions on the board (S7).

Then, the operator pushes down the manual handle 13 to press the press-fitting jig. The press-fit connector is pressed by the pressure head 22 via the press-fitting jig, and is press-fitted into the board (S8).

After the press-fit connector is press-fitted into the board and press fitting is completed, the operator releases the manual handle 13 (S9). Since the manual handle 13 and the pressure head 22 are urged by the spring so as to be recovered to upper positions, the manual handle 13 and the pressure head 22 are moved up. The pressure head support plate 21 that supports the pressure head 22 is moved up against the coil spring 16 beyond the operation origin that is the reference position. Then, the pressure head support plate 21 turns ON the switch 31 by the press rod 23 (S9). The shock absorbers 18 reduce the shock applied to the switch 31 when the press rod 23 presses the switch 31. By changing the damping factor of the shock absorbers 18, a variety of hand presses may be used.

If the operator holds and moves the manual handle 13 to the operation origin even after press fitting is completed, by pushing up the manual handle 13 beyond the operation origin, the switch 31 is turned ON (S9).

When the switch 31 is turned ON, the buzzer of the notifying unit 32 generates sound and the LED of the notifying unit 32 emits light to notify the operator that the count of press-fitting works is incremented (S10), and the ON information of the switch 31 is input to the PC 35 (S11).

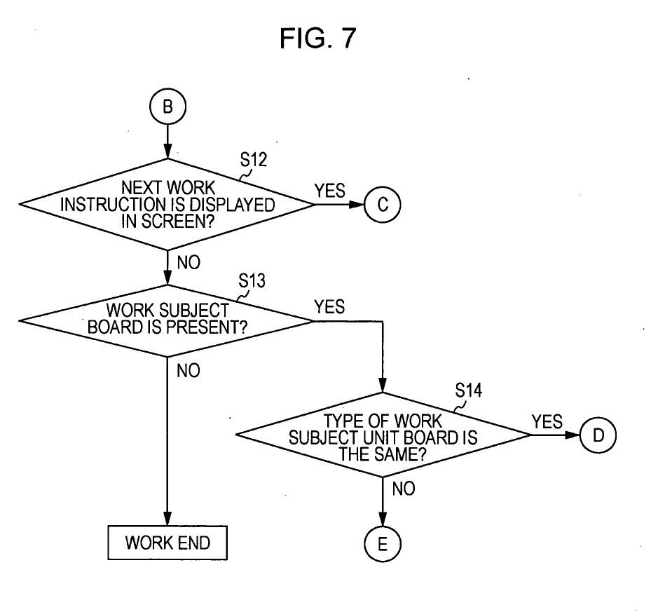

The PC 35 determines whether or not a connector to be press-fitted into the board still remains, on the basis of the count of press fitting. Referring to FIG. 7, if a connector to be press-fitted still remains, the type of connector, the type of jig, etc., are displayed in the screen as the instruction for the next work. Accordingly, the operator can recognize the instruction for the next work by referring to the screen of the PC 35 (S12).

If the instruction for the next work is displayed in the screen, the process returns to step S7 in FIG. 6, and the next press fitting of a connector is performed. If the next work instruction is not displayed in the screen in step S12, the operator checks whether or not a board for the next work is present (S13). If the board for the next work is present, whether or not the type of board for the next work is the same as the type of board in the current work is determined (S14).

If the type of board is the same as the type of board in the current work, the process returns to step S6 in FIG. 6, in which the work start button in the screen is pressed to start press fitting.

If the type of board for the next work is different from the type of board in the current work, the process returns to step S2 in FIG. 5, in which a board is selected, and then step S2 and the following steps are repeated.

If a board for the next work is not present in S13, the work is ended.

As described above, in this embodiment, the number of pressing works can be counted even for a press-fit connector with a different press height and a different press-fitting force. Further, by inputting information of the number of pressing works to the PC, the circuit board, the position of pressing, the type of connector, the type of press-fitting jig, and the notes for the work can be recognized, thereby reducing a work failure.

While press fitting of a press-fit connector is exemplarily described in this embodiment, a press subject is not limited thereto. Any type of hand press is applicable.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A hand press comprising:
an operation member provided at a main body;
a pressure head section including a pressure head movable up and down relative to the main body, the pressure head section configured to be pushed down by the operation member and to apply a pressing force;
an elastic member provided at the main body, the elastic member configured to apply an elastic force to the pressure head section such that a position of the pressure head located below a top dead center by a predetermined distance serves as an operation origin of the pressure head; and
a switch configured to be turned ON when the pressure head section is located at a position above the operation origin.

2. The hand press according to claim 1, wherein the switch is turned ON when the switch is pressed by a part of the pressure head section located at the position above the operation origin.

3. The hand press according to claim 1, further comprising:
a shock absorber provided at the elastic member.

4. The hand press according to claim 1, further comprising:
a display unit configured to display at least a type of press subject and a position of pressing,
wherein content displayed on the display unit is updated in response to ON information of the switch.
